(19) United States
(12) Patent Application Publication
(10) Pub. No.: US 2024/0289759 A1
(43) Pub. Date: Aug. 29, 2024

(54) METHOD AND SYSTEM FOR PERFORMING POST-TRANSFER INSTRUCTIONS

(71) Applicant: The Toronto-Dominion Bank, Toronto (CA)

(72) Inventors: Karen MAXWELL, Toronto (CA); Amanda BUCHANAN, Toronto (CA)

(73) Assignee: The Toronto-Dominion Bank, Toronto (CA)

(21) Appl. No.: 18/174,069

(22) Filed: Feb. 24, 2023

(51) Int. Cl. G06Q 20/10; H04L 67/53

(52) U.S. Cl. CPC G06Q 20/108; H04L 67/53

(57) ABSTRACT

A server computer system, comprises a processor; a communications module coupled to the processor; and a memory coupled to the processor, the memory storing instructions that, when executed, configure the processor to receive, via the communications module and from a third party server computer system, a transfer request that defines a transfer amount; obtain, via the communications module and from a client device, post-transfer instructions to offset a portion of the transfer amount; complete a transfer according to the transfer request; and perform the post-transfer instructions to offset the portion of the transfer amount.

### TECHNICAL FIELD

The present application relates to methods and systems for performing post-transfer instructions.

### BACKGROUND

In a computer network, resources may be shared or transferred between nodes of a network. For example, computing resources, such as processing units, memory, etc. may be transferred between nodes to attain a desired distribution of resources for a computer network.

Transfers are often completed based on transfer requests. Oftentimes, transfer requests only include instructions for completing the transfer.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a computing device;

FIG. 3 is a high-level schematic diagram of an example computer device;

FIG. 4 shows a simplified organization of software components stored in a memory of the example computer device of FIG. 3;

FIG. 5 is a flowchart showing operations performed by a server in performing post-transfer instructions according to an embodiment;

FIG. 6 is a schematic diagram illustrating nodes of a computing network connected to a shared resource according to an embodiment;

FIG. 7 is a schematic diagram illustrating nodes of a computing network where one of the nodes is connected to a dedicated resource according to an embodiment;

FIG. 8 is a schematic diagram illustrating nodes of a computing network connected to dedicated resources according to an embodiment;

FIG. 9 is an example graphical user interface for selecting a particular financial institution according to an embodiment;

FIG. 10 is an example graphical user interface for entering authentication information according to an embodiment;

FIG. 11 is an example graphical user interface for selecting an account according to an embodiment;

FIG. 12 is an example graphical user interface for defining post-transfer instructions;

FIG. 13 is another example graphical user interface for defining post-transfer instructions;

FIG. 14 is yet another example graphical user interface for defining post-transfer instructions; and

FIG. 15 is still yet another example graphical user interface for defining post-transfer instructions.

Like reference numerals are used in the drawings to denote like elements and features.

### DETAILED DESCRIPTION OF VARIOUS EMBODIMENTS

Accordingly, in one aspect there is provided a server computer system, comprising a processor; a communications module coupled to the processor; and a memory coupled to the processor, the memory storing instructions that, when executed, configure the processor to receive, via the communications module and from a third party server computer system, a transfer request that defines a transfer amount; obtain, via the communications module and from a client device, post-transfer instructions to offset a portion of the transfer amount; complete a transfer according to the transfer request; and perform the post-transfer instructions to offset the portion of the transfer amount.

In one or more embodiments, the post-transfer instructions include instructions to send at least one transfer request to offset the portion of the transfer amount.

In one or more embodiments, the post-transfer instructions include at least one electronic address for receiving the at least one transfer request.

In one or more embodiments, the post-transfer instructions define the portion of the transfer amount for each electronic address.

In one or more embodiments, the instructions, when executed, further configure the processor to verify an authentication status of the client device, and complete the transfer by transferring the transfer amount from an account associated with the client device.

In one or more embodiments, the transfer request includes a pay-by-bank request.

In one or more embodiments, completing the transfer includes transferring the transfer amount from an account associated with the client device to an account associated with the third party server computer system.

In one or more embodiments, the post-transfer instructions include a request for payment for transferring the portion of the transfer amount from one or more accounts to an account associated with the client device.

In one or more embodiments, the transfer request is received by way of an application programming interface redirect initiated by the third party server computer system.

In one or more embodiments, the transfer request identifies an account for receiving the transfer.

In one or more embodiments, the post-transfer instructions include sending a request for payment to at least one electronic address, the request for payment including a selectable link that, when selected, initiates payment from an account associated with the at least one electronic address to an account associated with the client device.

According to another aspect there is provided a computer-implemented method, comprising receiving, via a communications module and from a third party server computer system, a transfer request that defines a transfer amount; obtaining, via the communications module and from a client device, post-transfer instructions to offset a portion of the transfer amount; completing a transfer according to the transfer request; and performing the post-transfer instructions to offset the portion of the transfer amount.

In one or more embodiments, the post-transfer instructions include instructions to send at least one transfer request to offset the portion of the transfer amount.

In one or more embodiments, the post-transfer instructions include at least one electronic address for receiving the at least one transfer request.

In one or more embodiments, the post-transfer instructions define the portion of the transfer amount for each electronic address.

In one or more embodiments, the method further comprises verifying an authentication status of the client device; and completing the transfer by transferring the transfer amount from an account associated with the client device.

In one or more embodiments, the transfer request includes a pay-by-bank request.

In one or more embodiments, completing the transfer includes transferring the transfer amount from an account associated with the client device to an account associated with the third party server computer system.

In one or more embodiments, the transfer request is received by way of an application programming interface redirect initiated by the third party server computer system.

According to another aspect there is provided a non-transitory computer readable storage medium comprising processor-executable instructions which, when executed, configure a processor to receive, via a communications module and from a third party server computer system, a transfer request that defines a transfer amount; obtain, via the communications module and from a client device, post-transfer instructions to offset a portion of the transfer amount; complete a transfer according to the transfer request; and perform the post-transfer instructions to offset the portion of the transfer amount.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

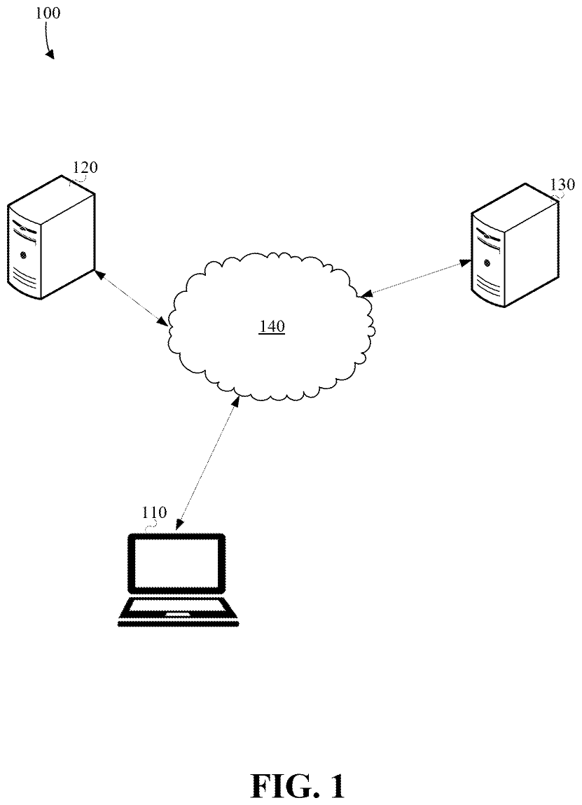

FIG. 1 is a block diagram illustrating an operating environment of an example embodiment. Various components cooperate to provide a system 100 which may be used, for example, to perform post-transfer instructions. As shown, the system 100 includes a client device 110, a server computer system 120 and a third party server computer system 130 coupled to one another through a network 140.

The client device 110 is configured to communicate with the server computer system 120 and the third party server computer system 130 via the network 140 and vice-versa. The client device 110 may be remote from the server computer system 120 and the third party server computer system 130.

The server computer system 120 is configured to communicate with the third party server computer system 130 via the network 140 and vice-versa. In one or more embodiments, the server computer system 120 may engage an application programming interface (API) that may be used to communicate with the third party server computer system 130 and vice-versa. The server computer system 120 may be remote from the third party server computer system 130.

The client device 110 may be a laptop computer as shown in FIG. 1. However, the client device 110 may be a computing device of another type such as for example a mobile device, a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The server computer system 120 may be referred to as a transfer server and may be configured to complete transfers according to transfer requests. In at least some embodiments, the server computer system 120 may transfer computing resources between different nodes in a computer network. In at least some embodiments, the server computer system 120 may be a financial institution server. In these embodiments, the server computer system 120 may maintain a database that includes various data records. A data record may, for example, reflect an amount of value stored in a particular account. The transfers may be completed by transferring value from a particular account maintained by the server computer system 120.

Each account maintained by the server computer system 120 may be associated with authentication information. The authentication information may be or may include any one or more of a token, a username, a password, a personal identification number (PIN), biometric data, etc. The authentication information may be used by the server computer system 120 to authenticate a device such as for example the client device 110. More specifically, the authentication information may be used to determine that the client device 110 is being operated by an authorized user and to identify the one or more accounts the user is trying to access.

The third party server computer system 130 may be maintained by a third party that does not maintain the server computer system 120. In one or more embodiments, the third party server computer system 130 may be referred to as a hypervisor or virtual machine monitor that may manage computer resource allocation for the server computer system 120.

In one or more embodiments, the third party server computer system 130 may be associated with a merchant and/or an e-commerce platform. The third party server computer system 130 may communicate transfer requests to the server computer system 120. As will be described in more detail, in one or more embodiments, the third party server computer system 130 may engage an API and may communicate transfer requests to the server computer system 120 by way of an API redirect.

The server computer system 120 and the third party server computer system 130 are computer systems. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The network 140 is a computer network. The network 140 may include a public network such as the Internet and/or a private network. In some embodiments, the network 140 may be an internetwork such as may be formed of one or more interconnected computer networks. For example, the network 140 may be or may include an Ethernet network, a wireless network, a telecommunications network, or the like.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components.

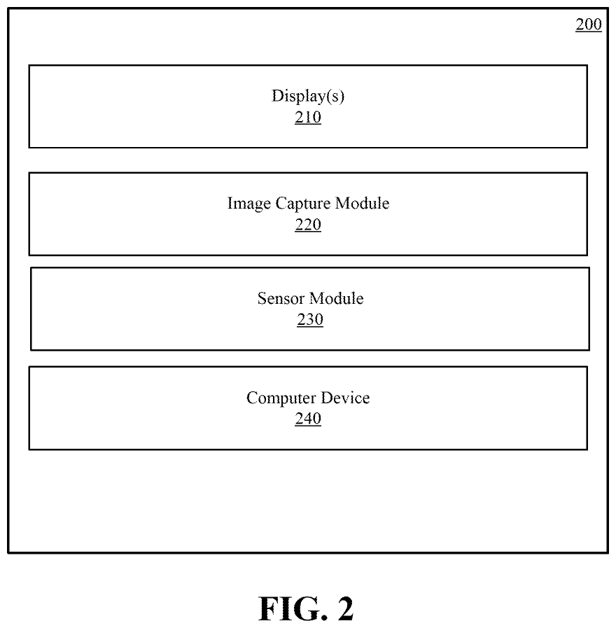

FIG. 2 is a simplified schematic diagram showing components of an exemplary computing device 200. The client device 110 may be of the same type as computing device 200. The computing device 200 may include modules including, as illustrated, for example, one or more displays 210, an image capture module 220, a sensor module 230, and a computer device 240.

The one or more displays 210 are a display module. The one or more displays 210 are used to display screens of a graphical user interface that may be used, for example, to communicate with the server computer system 120 (FIG. 1). The one or more displays 210 may be internal displays of the computing device 200 (e.g., disposed within a body of the computing device).

The image capture module 220 may be or may include a camera. The image capture module 220 may be used to obtain image data, such as images. The image capture module 220 may be or may include a digital image sensor system as, for example, a charge coupled device (CCD) or a complementary metal-oxide-semiconductor (CMOS) image sensor.

The sensor module 230 may be a sensor that generates sensor data based on a sensed condition. By way of example, the sensor module 230 may be or include a location subsystem which generates location data indicating a location of the computing device 200. The location may be the current geographic location of the computing device 200. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The computer device 240 is in communication with the one or more displays 210, the image capture module 220, and the sensor module 230. The computer device 240 may be or may include a processor which is coupled to the one or more displays 210, the image capture module 220, and/or the sensor module 230.

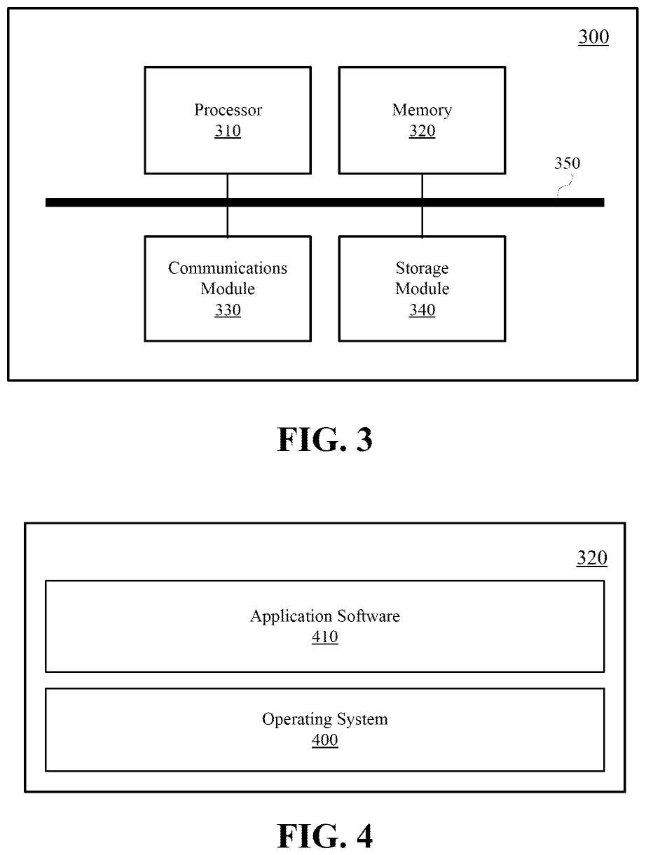

Referring now to FIG. 3, a high-level operation diagram of an example computer device 300 is shown. In some embodiments, the computer device 300 may be exemplary of the computer device 240 (FIG. 2), the server computer system 120 and/or the third party server computer system 130.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi (™), using Bluetooth (™) or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google (™) Android (™), Apple (™) iOS (™), UNIX (™), Linux (™), Microsoft (™) Windows (™), Apple OSX (™) or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2), the server computer system 120 and/or the third party server computer system 130.

While a single application 410 is illustrated in FIG. 4, in operation the memory 320 may include more than one application 410 and different applications 410 may perform different operations. For example, in at least some embodiments in which the computer device 300 functions as the client device 110, the applications 410 may include a banking application. The banking application may be configured for secure communications with the server computer system 120 and may provide various banking functions such as, for example, the ability to display a quantum of value in one or more data records (e.g., display balances), configure or request that operations such as transfers of value (e.g., bill payments, email money transfers and other transfers) be performed, and other account management functions. For example, the banking application may be configured to authenticate the user to authorize a transfer request that defines a transfer amount and to define post-transfer instructions to offset a portion of the transfer amount.

By way of further example, in at least some embodiments in which the computer device 300 functions as the client device 110, the applications 410 may include a web browser, which may also be referred to as an Internet browser. In at least some such embodiments, the server computer system 120 may be a web server. The web server may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g., display balances), configure or request that operations such as transfers of value (e.g. bill payments and other transfers) be performed, and other account management functions. For example, the banking interface may be configured to authenticate the user to authorize a transfer request that defines a transfer amount and to define post-transfer instructions to offset a portion of the transfer amount.

Further, as mentioned, in at least some embodiments the third party server computer system 130 may be associated with a merchant and/or an e-commerce platform. In these embodiments, the third party server computer system 130 may be a web server. The web server may cooperate with the web browser and may serve as an interface when the interface is requested through the web browser. For example, the web browser may serve as a payment interface for the merchant. The payment interface may enable a user operating the client device 110 to initiate payment for one or more products or services offered by the merchant. As another example, the web browser may serve as an e-commerce interface. The e-commerce interface may enable a user operating the client device 110 to shop for one or more products or services and to complete a purchase for the one or more products or services.

The user may operate the client device 110 to initiate a transfer and in response the third party server computer system 130 may cause the client device 110 to present an interface that includes a selectable option to deposit funds directly and in real-time to an account associated with the merchant. In response to selection of the selectable option to deposit funds directly and in real-time to an account associated with the merchant, the third party server computer system 130 may cause the client device 110 to present an interface that includes a list of financial institutions that are available to deposit funds directly and in real-time to the account associated with the merchant. Each financial institution displayed on the user interface may be selectable by the user. The user may select their financial institution and in response the third party server computer system 130 may perform operations to redirect or handoff completion of the transfer to the server computer system associated with the selected financial institution. The server computer system may include the server computer system 120 described herein.

In response to selection of the financial institution, the server computer system 120 may require authentication of the client device 110. As such, the server computer system 120 may perform operations that cause the client device 110 to request authentication information. The authentication information may be or may include any one or more of a token, a username, a password, a personal identification number (PIN), biometric data, etc. The authentication information may be used by the server computer system 120 to authenticate the client device 110. More specifically, the authentication information may be used to determine that the client device 110 is being operated by an authorized user and to identify an account for the transfer.

To redirect or handoff completion of the transfer, the third party server computer system 130 may engage an application programming interface (API) and the API may be associated with the server computer system 120. The API may be engaged by initiating an API call that includes at least a transaction amount and account details for receiving the transfer. The third party server computer system 130 may perform operations to complete an API redirect to the server computer system 120 and in this manner the completion of the transfer is redirected to the server computer system 120. The API redirect may be completed prior to authentication of the client device 110 or after authentication of the client device 110.

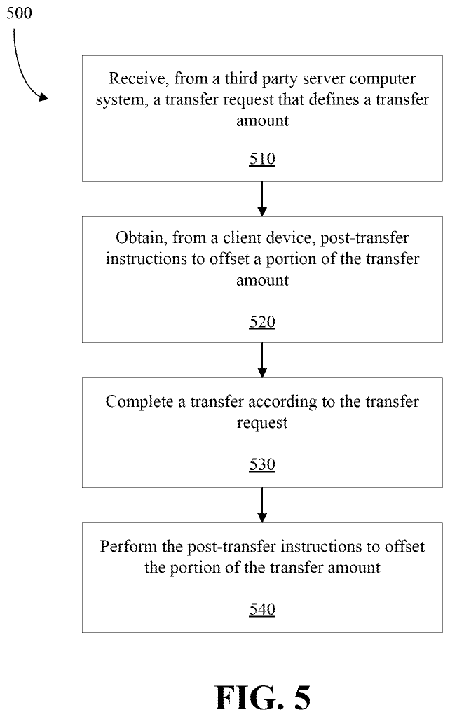

After successful authentication of the client device 110 and completion of the API redirect, the server computer system 120 may perform operations to complete the transfer and to perform post-transfer instructions. FIG. 5 is a flowchart showing operations performed in performing post-transfer instructions according to an embodiment. The operations may be included in a method 500 which may be performed by the server computer system 120. For example, computer-executable instructions stored in memory of the server computer system 120 may, when executed by one or more processors, configure the server computer system 120 to perform the method 500 or a portion thereof. The server computer system 120 may offload some of the operations to the client device 110 and/or the third party server computer system 130.

The method 500 includes receiving, from a third party server computer system, a transfer request that defines a transfer amount (step 510).

In one or more embodiments, the transfer request may include a request for computing resources and may define an amount of computing resources to be transferred or allocated to one or more nodes of a computing network. For example, the transfer request may define a particular amount of memory to be transferred or allocated to one or more nodes of the computing network.

In one or more embodiments, the transfer request may be received by way of the API redirect initiated by the third party server computer system 130. For example, as mentioned above, the third party server computer system 130 may engage an API that may be associated with the server computer system 120. The API may be engaged by initiating an API call that includes at least a transaction amount and account details for receiving the transfer. The third party server computer system 130 may perform operations to complete an API redirect to the server computer system 120 and in this manner the completion of the transfer is redirected to the server computer system 120. The API redirect may be completed prior to authentication of the client device 110 or after authentication of the client device 110. In these embodiments, the transfer request may include a pay-by-bank request.

In one or more embodiments, the transfer request may be received directly from the third party server computer system 130. For example, the third party server computer system 130 may store, in a database, protocol information that may be used to generate the transfer request in a format that is compliant with requirements of the server computer system 120. In this example, in response to selection of the financial institution associated with the server computer system 120, the third party server computer system 130 may consult the database to determine the format that is compliant with requirements of the server computer system 120 and may generate the transfer request accordingly.

In another example, the third party server computer system 130 may request the format from a dedicated server computer system that may be associated with another third party. The dedicated server computer system may be available to any requesting party (such as the third party server computer system 130) and may provide the requesting party with the format complaint with any particular financial institution. In this example, in response to selection of the financial institution associated with the server computer system 120, the third party server computer system 130 may obtain the format that is compliant with requirements of the server computer system 120 from the dedicated server computer system and may generate the transfer request accordingly.

The transfer request includes the transfer amount. In one or more embodiments, such as when the transfer request includes a pay-by-bank request, the transfer request may identify an account associated with the third party server computer system 130 that is to receive the transfer. The account may be an account hosted by a financial institution associated with the server computer system 120 or may be an account hosted by a different financial institution.

In one or more embodiments, the transfer request may include additional data such as for example data indicating the items being purchased for the transfer.

The method 500 includes obtaining, from a client device, post-transfer instructions to offset a portion of the transfer amount (step 520).

In one or more embodiments, the post-transfer instructions may include instructions to reassign or dedicate computing resources to offset at least a portion of the amount of computing resources transferred or allocated to the one or more nodes of the computing network. For example, the post-transfer instructions may define one or more external or virtual memory devices that are to be made available for one or more nodes of the computing network.

In one or more embodiments, in response to the API redirect, the server computer system 120 may communicate with the client device 110 and may cause the client device to display one or more graphical user interfaces. The one or more graphical user interfaces may include one or more graphical user interfaces that may be used to define the post-transfer instructions to offset the portion of the transfer amount.

The post-transfer instructions are instructions that the server computer system 120 must execute upon completion of the transfer request. The post-transfer instructions are required to be completed by the server computer system 120 and not the third party server computer system 130. In this manner, the reliance on the third party server computer system 130 is reduced. Put another way, once the transfer request has been redirected to the server computer system 120, the third party server computer system 130 is not required to complete the transfer or the post-transfer instructions. This may reduce network traffic and/or network bandwidth.

In one or more embodiments, the post-transfer instructions may include instructions to send at least one transfer request to offset the portion of the transfer amount. For example, the transfer amount may be based on payment for one or more products or services offered by a merchant associated with the third party server computer system 130 and the user of the client device 110 may wish to offset a portion of the transfer amount by requesting payment from one or more accounts associated with one or more people.

For example, the transfer amount may be based on payment for a bill at a particular restaurant. In this example, the user of the client device 110 may wish to offset a portion of the bill by requesting payment from one or more friends that ate with them at the restaurant. As such, the post-transfer instructions may include instructions to send at least one transfer request to the one or more friends.

In one or more embodiments, the post-transfer instructions may include at least one electronic address for receiving the at least one transfer request. In these embodiments, the at least one electronic address may include an email address, a phone number, etc. that may be used to send the at least one transfer request to request payment.

In one or more embodiments, the post-transfer instructions may define a portion of the transfer amount for each electronic address. For example, the post-transfer instructions may indicate that the transfer amount is to be split evenly amongst all parties and as such each electronic address may be assigned an equal portion of the transfer amount. As another example, the post-transfer instructions may define a particular portion of the transfer amount and this may be defined by the user operating the client device 110. As yet another example, the post-transfer instructions may assign one or more items that were purchased in a transaction that initiated the transfer request and this may be assigned by the user operating the client device 110.

In one or more embodiments, the post-transfer instructions may include a request for payment for transferring the portion of the transfer amount from one or more accounts to an account associated with the client device 110.

In one or more embodiments, the post-transfer instructions may include sending a request for payment to at least one electronic address. The request for payment may include a selectable link that, when selected, initiates payment from an account associated with the at least one electronic address to an account associated with the client device 110.

In one or more embodiments, the request for payment may be a specially formatted message that is sent from the server computer system 120 to another server computer system associated with a different financial institution. The request for payment may be sent from the server computer system 120 to the other server computer system over a transfer rail that is used for facilitating transfers between databases associated with different database management systems. For example, the server computer system 120 may be associated with a first database and the other server computer system may be associated with a second database. The databases may store account data. That is, the databases may store data that is associated with various accounts. In at least some implementations, each record in the database may be associated with a particular one of these accounts.

A request for payment is a message that is sent on behalf of a recipient, which in one or more embodiments is a user associated with the client device 110, to initiate a transfer from a sender to the recipient. That is, the request for payment is sent, on behalf of the recipient, from the server computer system 120 associated with the recipient to the other server computer system associated with the sender. The request for payment requests a transfer from a record in the database that is associated with the sender to a record in the database that is associated with the recipient. The request for payment includes one or more identifiers that identify the record associated with the sender and/or the record associated with the recipient. The identifier(s) may be or include an account number. The request for payment may also include one or more identifiers that identify the server computer system 120 associated with the sender and/or that identify the other server computer system associated with the recipient. Such identifiers may be or include one or more of a transit number and an institution number.

The request for payment is a transfer initiation message. That is, the request for payment is an initial message that may be used to cause a transfer to occur. Since the request for payment is initiated by a recipient rather than a sender, the request for payment may be considered to a pull-style transfer, which may be contrasted with typical push-style transfers. In at least some implementations, the request for payment may be formatted as an ISO20022 message.

The request for payment message is specially formatted to include parameters of a transfer that is requested to be made from a sender. The parameters may be included as metadata in the transfer message. Where the request for payment is an ISO20022 message, the parameters may be included in an ISO20022 format. The parameters may include resource definition data. The resource definition data defines what is requested to be transferred. By way of example, the resource definition data may define a resource that is stored in or otherwise associated with a record associated with the sender. The resource may represent an amount of value, such as a quantity of a currency.

The request for payment may be referred to as a request for payment (RFP) message or a request to pay (RTP) message. In such implementations, the transfer rail may be a payment rail such as a real time payment rail and the server computer systems may be associated with financial institutions. In at least some such implementations, the records may represent bank accounts and a transfer may be a request for payment value from a sender bank account to the recipient bank account. The request for payment message may be sent from a first financial institution system, which is associated with a first financial institution, to a second financial institution system, which is associated with a second financial institution.

In one or more embodiments, the request for payment message is a special transfer message which is not formatted as an email or short message service (SMS) message. Rather, it is a computer-to-computer message that is formatted to be specially processed by the server computer system that receives it. In at least some implementations, the computer-to-computer message may be formatted according to the ISO20022 standard. For example, the server computer system that receives the request for payment message may be configured to execute a process for obtaining authorization to complete a transfer in response to receiving the request for payment. More particularly, the server computer systems may be configured to only permit authorized transfers. For example, in one implementation, the database stores account data for a plurality of accounts and a server computer system will only allow a transfer out of an account if the transfer is authorized by an authorization entity for that account, such as an account holder. Authorization may, for example, require authenticated approval using a credential such as one or more of a username, password, biometric authentication data or other credential.

In one implementation, in response to receiving the transfer message, a server computer system may identify an affected account using an identifier defined by the transfer message. Then, the server computer system may send an electronic notification to a client device associated with the identified account. This notification may be provided as an in-application notification or operating system level notification. The notification may include a selectable option to authorize the transfer.

The notification may allow the transfer to be made without requiring input of one or more parameters that are typically required when a transfer is initiated by the sender rather than the recipient. By way of example, one or more parameters that are included in the request for payment may be used to pre-stage or pre-populate parameters of the transfer so that the sender does not have to input such parameters. In some implementations, the resource definition data included in the request for payment may be used to allow the transfer to be made without having the sender define what is to be transferred. For example, where the transfer is a transfer of an amount of value, the amount of value defined in the request for transfer message may be used so that the sender does not have to define the amount of value.

In this way, the sender may cause a server computer system that is associated with the sender's record in a database to perform the transfer without having to input any parameters for the transfer. The time and/or amount of the transfer may be extracted directly from the request for payment message. The sender may only need to input an indication of consent to initiate the transfer when the sender has authenticated to the server computer system and the transfer may then be performed.

The method 500 includes completing a transfer according to the transfer request (step 530).

In one or more embodiments, the server computer system 120 may perform operations to transfer or allocate the amount of computing resources to the one or more nodes of the computing network. For example, the server computer system 120 may actuate one or more switches to dedicate the computing resources to the one or more nodes of the computing network. As another example, the server computer system 120 may update a memory table to dedicate the computing resources to the one or more nodes of the computing network.

In one or more embodiments, the server computer system 120 verifies an authentication status of the client device 110 prior to completing the transfer. For example, the server computer system 120 may determine whether or not the client device 110 has been successfully authenticated. If the client device 110 has not been authenticated, the server computer system 120 may perform operations that cause the client device 110 to request authentication information. The authentication information may be or may include any one or more of a token, a username, a password, a personal identification number (PIN), biometric data, etc. The authentication information may be used by the server computer system 120 to authenticate the client device 110.

Once the authentication status of the client device 110 has been verified, the server computer system 120 may perform operations to complete the transfer by transferring the transfer amount from an account associated with the client device directly to an account associated with the third party server computer system.

The method 500 includes performing the post-transfer instructions to offset the portion of the transfer amount (step 540).

Once the transfer has been completed, the server computer system 120 performs the post-transfer instructions to offset the portion of the transfer amount.

The post-transfer instructions may include instructions to reassign or dedicate computing resources to offset at least a portion of the amount of computing resources transferred or allocated to the one or more nodes of the computing network. As such, the server computer system 120 performs operations to reassign or dedicate the computing resources to offset the at least a portion of the amount of computing resources transferred or allocated to the one or more nodes of the computing network.

As one example, the post-transfer instructions may define one or more external or virtual memory devices that are to be made available for one or more nodes of the computing network. As such, the server computer system 120 may perform operations to make available the one or more external or virtual memory devices to one or more nodes of the computing network. In this manner, the post-transfer instructions may be performed to ensure that computing resources are available to nodes of the computing network that did not receive the benefit of the transferred or allocated computing resources.

The post-transfer instructions may include instructions to send at least one transfer request to offset the portion of the transfer amount. As such, the server computer system 120 sends at least one transfer request to offset the portion of the transfer amount.

As another example, the post-transfer instructions may include instructions to send at least one transfer request to at least one electronic address. As such, the server computer system 120 sends the at least one transfer request to the at least one electronic address. As mentioned, the post-transfer instructions may define a portion of the transfer amount for each electronic address. As such, the at least one transfer request may include the portion of the transfer amount for each electronic address.

As another example, the post-transfer instructions may include a request for payment for transferring the portion of the transfer amount from one or more accounts to an account associated with the client device 110. As such, the server computer system 120 sends the request for payment for transferring the portion of the transfer amount from one or more accounts to an account associated with the client device 110.

As yet another example, the post-transfer instructions may include sending a request for payment to at least one electronic address. The request for payment may include a selectable link that, when selected, initiates payment from an account associated with the at least one electronic address to an account associated with the client device 110. As such, the server computer system 120 sends the request for payment to the at least one electronic address such that the request for payment includes the selectable link that, when selected, initiates payment from the account associated with the at least one electronic address to the account associated with the client device 110.

In manners described herein, the post-transfer instructions are instructions that the server computer system 120 must execute upon completion of the transfer request. The post-transfer instructions are completed by the server computer system 120 and not the third party server computer system 130. In this manner, the reliance on the third party server computer system 130 is reduced. Put another way, once the transfer request has been redirected to the server computer system 120, the third party server computer system 130 is not required to complete the transfer or the post-transfer instructions and as a result this may reduce network traffic and/or network bandwidth.

In manners described herein where the transfer request includes a pay-by-bank request, payment is automatically deposited from an account associated with the server computer system 120 into an account associated with the third party server computer system 130. This is completed in real-time. Further, the overall use of computing resources is reduced as the user operating the client device 110 is not required to enter payment information and the third party server computer system 130 is not required to store payment information in memory. Still further, since payment information is not stored by the third party server computer system 130, the overall risk of potential fraud is reduced.

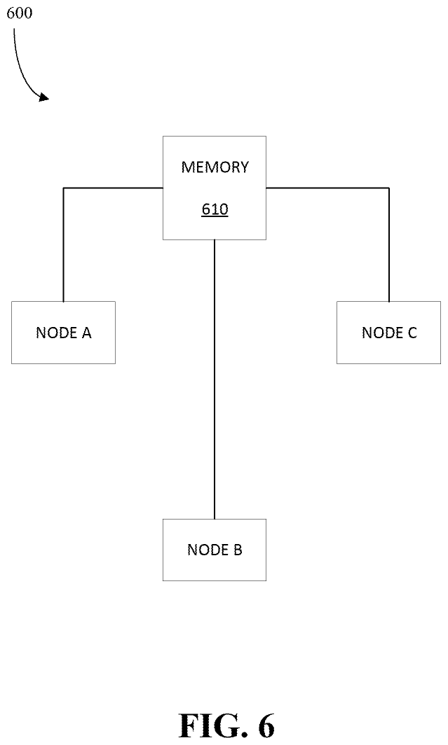

An example of a transfer request for computing resources in a computing network will now be described with reference to FIGS. 6 to 8. An example schematic diagram illustrating nodes of a computing network connected to a shared resource is shown in FIG. 6. As can be seen, a computing network 600 includes a node A, a node B, and a node C. Each one of the nodes A, B, C is connected to a shared resource 610 which in this example is memory.

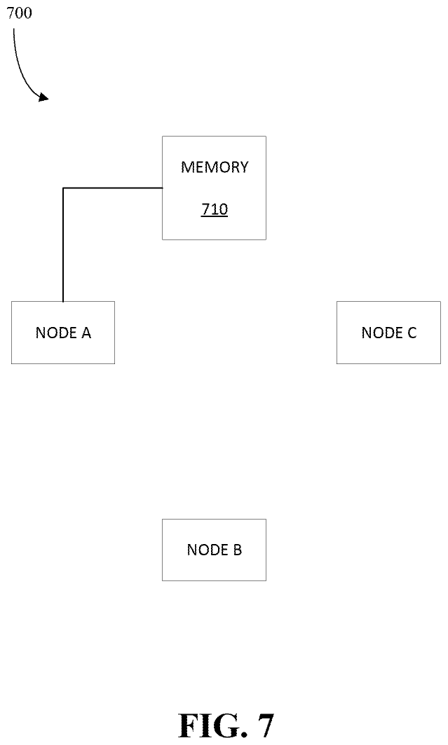

In this example, a transfer request is received to transfer or allocate the memory to one of the nodes, specifically to node A. As such, the server computer system 120 performs operations to allocate the memory to node A. An example schematic diagram illustrating nodes of a computing network where one of the nodes is connected to a dedicated resource is shown in FIG. 7. As can be seen, a computing network 700 includes a node A connected to a dedicated resource 710 which in this example is memory.

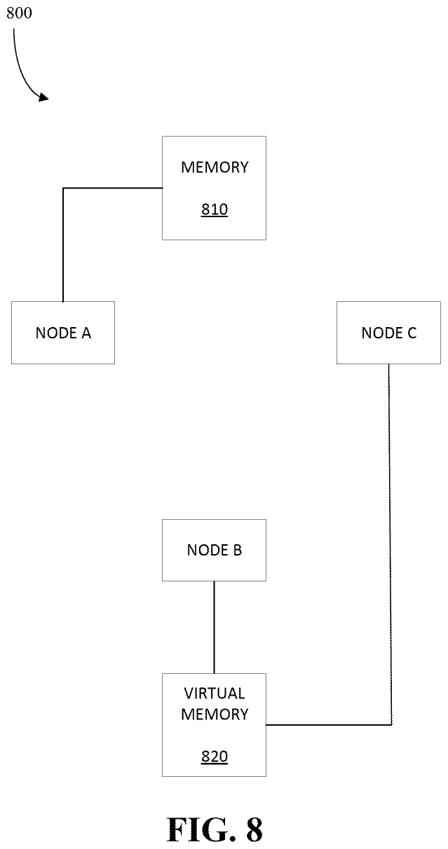

In this example, the post-transfer instructions may define that virtual memory is to be accessed and made available to the nodes B and C. As such, the server computer system 120 performs the post-transfer instructions to make available the virtual memory to the nodes B and C. An example schematic diagram illustrating nodes of a computing network where one of the nodes is connected to dedicated resources is shown in FIG. 8. As can be seen, a computing network 800 includes a node A connected to a dedicated resource 810 which in this example is memory and node B and node C connected to a dedicated resource 820 which in this example is virtual memory.

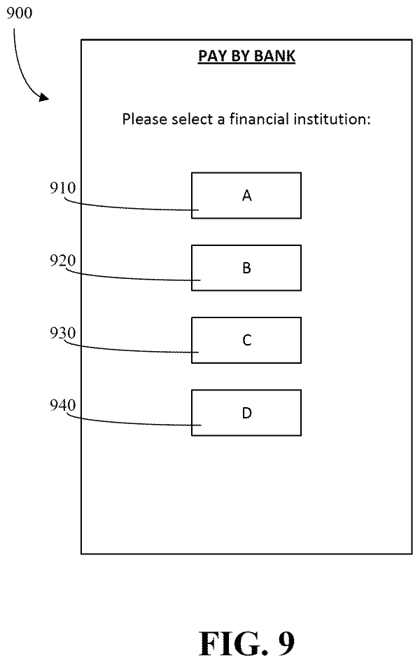

As mentioned, in one or more embodiments the transfer request described herein may include a pay-by-bank request. Example user interfaces that may be displayed on the client device 110 during the pay-by-bank request are shown in FIGS. 9 to 15.

FIG. 9 includes a graphical user interface 900 that may be displayed on the client device 110 upon initiation of a pay-by-bank request. As can be seen, the graphical user interface 900 includes selectable options 910, 920, 930 and 940 to select a particular financial institution. The user operating the client device 110 may select their financial institution by performing, for example, a tap gesture at a location on a display screen of the client device 110 that corresponds to the location of the selectable option associated with their financial institution. In response to selection of the selectable option, the third party server computer system 130 may perform operations to handoff the pay-by-bank request to the server computer system 120.

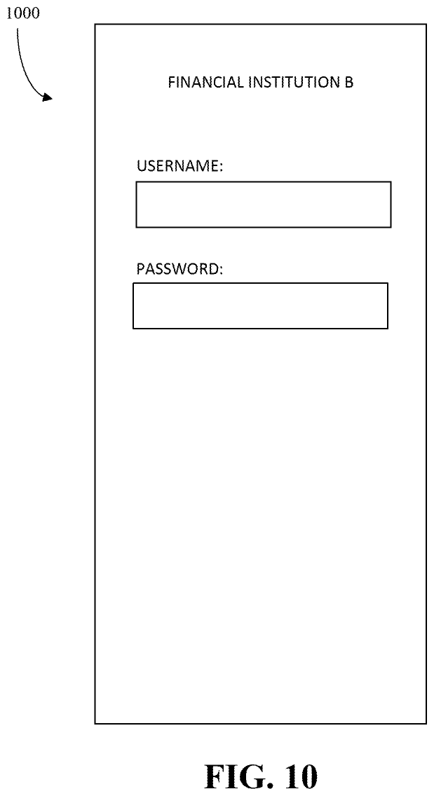

FIG. 10 includes a graphical user interface 1000 that may be displayed on the client device 110 requesting authentication information, specifically a username and a password. The server computer system 120 may cause the client device 110 to display the graphical user interface 1000 and this may be done in response to a successful handoff of the pay-by-bank request from the third party server computer system 130 to the server computer system 120. The user may provide the authentication information using an input device such as a virtual keyboard associated with the client device 110. In response to submission of the authentication information, the server computer system 120 may perform operations to authenticate the client device 110 and to identify one or more accounts associated therewith.

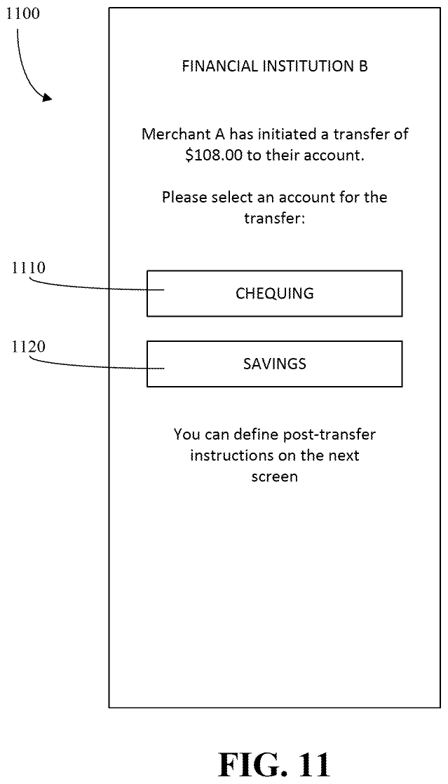

FIG. 11 includes a graphical user interface 1100 that may be displayed on the client device 110 after successful authentication. The server computer system 120 may cause the client device 110 to display the graphical user interface 1100 and this may be done in response to successful authentication. The graphical user interface 1100 displays information related to the pay-by-bank request and includes selectable options 1110, 1120 associated with different accounts of the user of the client device 110. The user operating the client device 110 may select which account they would like to use for the pay-by-bank by performing, for example, a tap gesture at a location on a display screen of the client device 110 that corresponds to the location of the selectable option associated with the desired account. In response to selection of the selectable option, the server computer system 120 may perform operations to initiate the pay-by-bank transfer and to request post-transfer instructions.

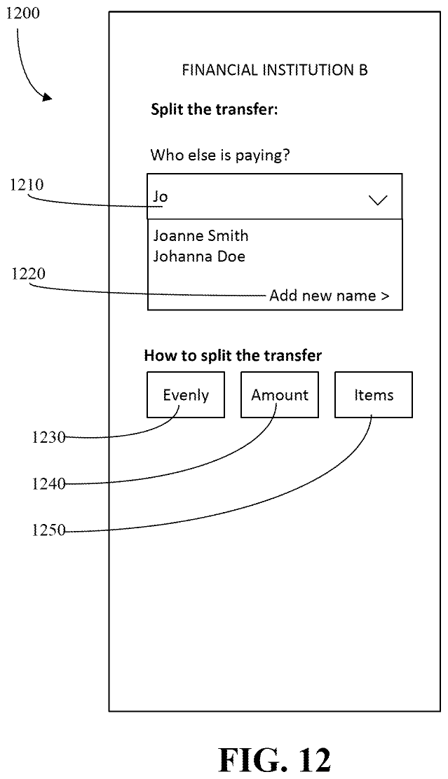

FIG. 12 includes a graphical user interface 1200 that may be displayed on the client device 110 to define post-transfer instructions. The server computer system 120 may cause the client device 110 to display the graphical user interface 1200. The graphical user interface 1200 includes an interface element 1210 in the form of a drop down menu that may be used to select one or more people to reduce or offset a portion of the transfer amount. The user may select one or more people from the drop down list. The graphical user interface 1200 includes a selectable option 1220 for adding a new person to the drop down list. Adding a new person may include providing a name of the person and an electronic address of the person. The graphical user interface 1200 includes selectable options for defining how to split the transfer. Specifically, the graphical user interface 1200 includes a selectable option 1230 for splitting the transfer evenly, a selectable option 1240 for splitting the transfer by defining an amount for each person, and a selectable option 1250 for splitting the transfer by assigning one or more items to each person.

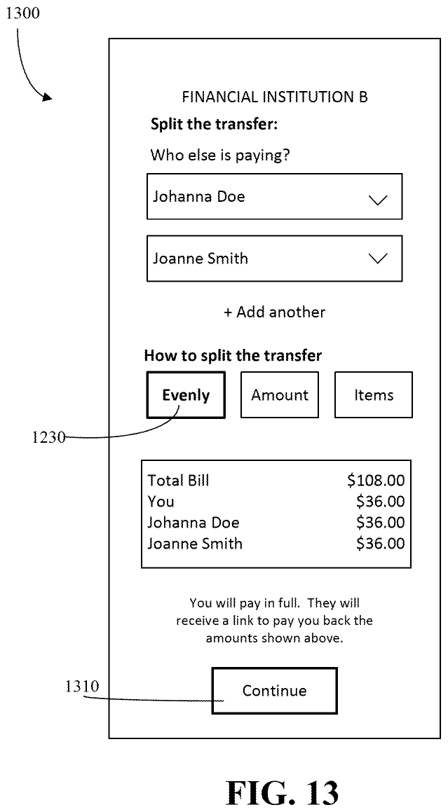

Selection of the selectable option 1230 for splitting the transfer evenly may cause the server computer system 120 to update the graphical user interface as shown in FIG. 13 as graphical user interface 1300. As can be seen, the selectable option 1230 is displayed in a different format (compared to that shown in FIG. 12) to indicate selection thereof. The graphical user interface 1300 displays information indicating the portion of the transfer amount that each person is responsible for. The graphical user interface 1300 includes a selectable option 1310 that, when selected, indicates completion of defining the post-transfer instructions.

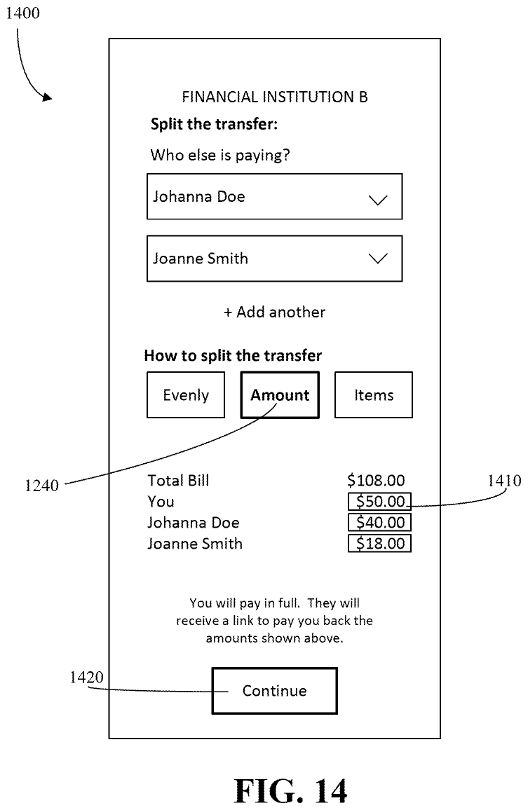

Selection of the selectable option 1240 for splitting the transfer by defining an amount for each person may cause the server computer system 120 to update the graphical user interface as shown in FIG. 14 as graphical user interface 1400. As can be seen, the selectable option 1240 is displayed in a different format (compared to that shown in FIG. 12) to indicate selection thereof. The graphical user interface 1400 includes interface elements 1410 that may be completed by the user operating the client device 110 to define the amount each person is responsible for paying. It will be appreciated that in embodiments where one or more of the interface elements 1410 have not been completed by the user, the balance of the total bill may be assigned to the user operating the client device 110. This amount may be automatically updated based on the amounts entered for the other people displayed on the graphical user interface 1400. The graphical user interface 1400 includes a selectable option 1420 that, when selected, indicates completion of defining the post-transfer instructions.

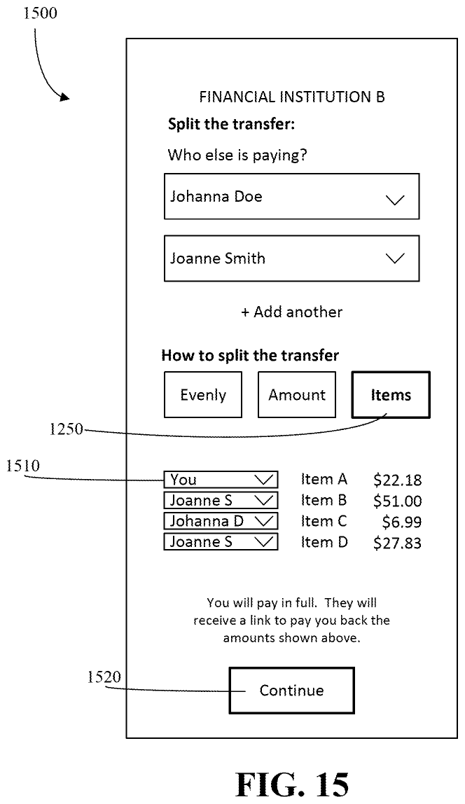

Selection of the selectable option 1250 for splitting the transfer by assigning one or more items to each person may cause the server computer system 120 to update the graphical user interface as shown in FIG. 15 as graphical user interface 1500. As can be seen, the selectable option 1250 is displayed in a different format (compared to that shown in FIG. 12) to indicate selection thereof. The graphical user interface 1500 includes interface elements 1510 in the form of a drop down menu that may be used to select which person is responsible for which item(s) of the bill. The drop down menu may be populated based on which people have selected to split the transfer. The graphical user interface 1500 includes a selectable option 1520 that, when selected, indicates completion of defining the post-transfer instructions.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A server computer system, comprising:
a processor;
a communications module coupled to the processor; and
a memory coupled to the processor, the memory storing instructions that, when executed, configure the processor to:
receive, via the communications module and from a third party server computer system, a transfer request that defines a transfer amount;
obtain, via the communications module and from a client device, post-transfer instructions to offset a portion of the transfer amount;
complete a transfer according to the transfer request; and
perform the post-transfer instructions to offset the portion of the transfer amount.

2. The server computer system of claim 1, wherein the post-transfer instructions include instructions to send at least one transfer request to offset the portion of the transfer amount.

3. The server computer system of claim 2, wherein the post-transfer instructions include at least one electronic address for receiving the at least one transfer request.

4. The server computer system of claim 3, wherein the post-transfer instructions define the portion of the transfer amount for each electronic address.

5. The server computer system of claim 1, wherein the instructions, when executed, further configure the processor to:
verify an authentication status of the client device; and
complete the transfer by transferring the transfer amount from an account associated with the client device.

6. The server computer system of claim 1, wherein the transfer request includes a pay-by-bank request.

7. The server computer system of claim 6, wherein completing the transfer includes transferring the transfer amount from an account associated with the client device to an account associated with the third party server computer system.

8. The server computer system of claim 1, wherein the post-transfer instructions include a request for payment for transferring the portion of the transfer amount from one or more accounts to an account associated with the client device.

9. The computer server system of claim 1, wherein the transfer request is received by way of an application programming interface redirect initiated by the third party server computer system.

10. The computer server system of claim 1, wherein the transfer request identifies an account for receiving the transfer.

11. The computer server system of claim 1, wherein the post-transfer instructions include sending a request for payment to at least one electronic address, the request for payment including a selectable link that, when selected, initiates payment from an account associated with the at least one electronic address to an account associated with the client device.

12. A computer-implemented method, comprising:
receiving, via a communications module and from a third party server computer system, a transfer request that defines a transfer amount;
obtaining, via the communications module and from a client device, post-transfer instructions to offset a portion of the transfer amount;
completing a transfer according to the transfer request; and
performing the post-transfer instructions to offset the portion of the transfer amount.

13. The computer-implemented method of claim 12, wherein the post-transfer instructions include instructions to send at least one transfer request to offset the portion of the transfer amount.

14. The computer-implemented method of claim 13, wherein the post-transfer instructions include at least one electronic address for receiving the at least one transfer request.

15. The computer-implemented method of claim 14, wherein the post-transfer instructions define the portion of the transfer amount for each electronic address.

16. The computer-implemented method of claim 12, further comprising:
verifying an authentication status of the client device; and
completing the transfer by transferring the transfer amount from an account associated with the client device.

17. The computer-implemented method of claim 12, wherein the transfer request includes a pay-by-bank request.

18. The computer-implemented method of claim 17, wherein completing the transfer includes transferring the transfer amount from an account associated with the client device to an account associated with the third party server computer system.

19. The computer-implemented method of claim 12, wherein the transfer request is received by way of an application programming interface redirect initiated by the third party server computer system.

20. A non-transitory computer readable storage medium comprising processor-executable instructions which, when executed, configure a processor to:
receive, via a communications module and from a third party server computer system, a transfer request that defines a transfer amount;
obtain, via the communications module and from a client device, post-transfer instructions to offset a portion of the transfer amount;
complete a transfer according to the transfer request; and
perform the post-transfer instructions to offset the portion of the transfer amount.
